(19) United States
(12) Patent Application Publication
(10) Pub. No.: US 2006/0222170 A1
(43) Pub. Date: Oct. 5, 2006

(54) External system to provide an electronic device with access to memory external to the electronic device

(76) Inventors: Nick L. Payzant, Monarch Beach, CA (US); Erik W. Jones, Coto de Caza, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/328,736

(22) Filed: Jan. 10, 2006

Related U.S. Application Data
(60) Provisional application No. 60/667,220, filed on Mar. 31, 2005.

(51) Int. Cl. H04M 1/00

(52) U.S. Cl. 379/357.05

(57) ABSTRACT

An external system is provided for use with an electronic device. The device has a device housing and a dataport, and is powered from within the housing. The external system includes an apparatus held to the electronic device in an external location relative to the electronic device. The apparatus is configured to provide the electronic device with access to a source of memory external to the device. The apparatus does not negatively impact handling of the electronic device during use of the electronic device. The external system further includes one or more conduits which are configured to transmit signals between the apparatus and the dataport. The conduits are configured to be affixed to the housing so as to closely follow a contour of the housing.

### CROSS-REFERENCE TO RELATED APPLICATIONS

This application claims the benefit of U.S. Provisional Patent Application No. 60/667,220, filed Mar. 31, 2005, which is incorporated in its entirety by reference herein.

### BACKGROUND OF THE INVENTION

1. Field of the Invention

The present invention relates to systems and methods for providing an electronic device with access to additional data storage space.

2. Description of the Related Art

In recent years, the use of personal mobile communication devices including cellular phones or PCS (personal communication system) phones has increased. Consumers are commonly offered a variety of functions in these cellular phones, including built-in music players, media players, digital cameras, and built-in personal digital assistants (PDA). Paralleling the growth and complexity of features offered with cellular telephones is the need for memory with which to store data. In addition to storing telephone numbers in the cellular telephone, users also often store music files, image files, media files, or other digital files that quickly fill the limited amount of storage space that is provided with a cellular telephone. Consequently, much more data storage space is needed.

Data storage sometimes comes in the form of rotating-storage drives (e.g., hard disk drives, optical disk drives). A hard disk drive is a data storage device that stores data on magnetic surfaces layered onto rotating hard disks or platters. Hard disk drives are examples of Non-Volatile Read Write Memory (NVRWM) that can maintain its stored data without power. Each disk has a planar magnetic surface on which digital data may be stored. Information is written to the disk by transmitting an electromagnetic flux through an antenna or read-write head that is very close to the magnetic surface, with the flux changing the polarization of the surface in a localized region in proximity to the read-write head. Previously written information can be read by a read-write head which senses the magnetic fields of regions of the surface as they pass by in close proximity to the read-write head as the disk rotates. Hard drives are available in very small sizes called “microdrives.”

Additional data storage space may also be provided in the form of flash memory, which is a type of electrically erasable programmable read only memory (EEPROM). Flash memory is another example NVRWM and can thus retain its contents without power for an indefinitely long time or until it is rewritten. In addition, flash memory offers fast read access times and improved shock resistance compared to hard disks.

### SUMMARY OF THE INVENTION

In certain embodiments, an external flash memory system is provided for use with a cellular telephone that includes an 8-pin dataport and a telephone housing. The cellular telephone is powered from within the telephone housing. The external flash memory system comprises a resilient support configured to have a decorative appearance. The support is further configured to be affixed to an external surface of the telephone housing by an adhesive. The support does not negatively impact handling of the telephone during use of the telephone. The external flash memory system further comprises a low-profile flash memory device supported by the support. The flash memory device comprises a flash memory integrated circuit, a printed circuit board electrically coupled to the flash memory integrated circuit, and a controller integrated circuit electrically coupled to the printed circuit board for controlling data transmission to and from the flash memory integrated circuit. The external flash memory system further comprises a plurality of electrical conduits configured to electrically couple the flash memory device to the 8-pin dataport of the cellular telephone. The conduits are configured to be affixed to the telephone housing so as to closely follow a contour of the housing.

In certain embodiments, an external system is provided for use with an electronic device. The device has a device housing and a dataport, and is powered from within the housing. The external system comprises an apparatus held to the electronic device in an external location relative to the electronic device. The apparatus is configured to provide the electronic device with access to a source of memory external to the device. The apparatus does not negatively impact handling of the electronic device during use of the electronic device. The external system further comprises one or more conduits which are configured to transmit signals between the apparatus and the dataport. The conduits are configured to be affixed to the housing so as to closely follow a contour of the housing.

In certain embodiments, an external memory system is provided for use with an electronic device that includes a device housing and that is powered from within the housing. The external memory system comprises a memory device held to the electronic device in an external location relative to the electronic device. The memory device does not negatively impact handling of the electronic device during use of the electronic device. The external memory system further comprises one or more electrical conduits which are configured to electrically couple the memory device to a dataport of the electronic device. The conduits are configured to be affixed to the housing so as to closely follow a contour of the housing.

In certain embodiments, an electronic apparatus comprises a cellular telephone that includes a telephone housing and a dataport. The cellular telephone is powered from within the telephone housing. The electronic apparatus further comprises a memory system which comprises a package mountable on an external surface of the cellular telephone, and a memory device held by the package in an external location relative to the cellular telephone. The electronic apparatus further comprises one or more electrical conduits which are configured to electrically couple the memory device to the dataport. The conduits are configured to be affixed to the housing so as to closely follow a contour of the housing.

In certain embodiments, an external system is provided for use with an electronic device. The device has a device housing and a dataport and is powered from within the housing. The external system comprises access means for providing access to a source of memory external to the device. The access means is held to the electronic device in an external location relative to the electronic device. The access means does not negatively impact handling of the electronic device during use of the electronic device. The external system further comprises packaging means for coupling the access means to an external surface of the housing. The external system further comprises transmitting means for transmitting signals between the access means and the dataport. The transmitting means is configured to be affixed to the housing so as to closely follow a contour of the housing.

In certain embodiments, an external coupler is provided for use with an electronic device that includes a device housing and a dataport and is powered from within the housing. The external coupler comprises a communication interface held to the electronic device in an external location relative to the electronic device. The communication interface is configured to be operatively coupled to a source of memory external to the electronic device. The communication interface does not negatively impact handling of the electronic device during use of the electronic device. The external coupler further comprises one or more conduits configured to transmit signals between the communication interface and the dataport. The conduits are configured to be affixed to the housing so as to closely follow a contour of the housing.

### BRIEF DESCRIPTION OF THE DRAWINGS

These and other features will now be described with reference to the drawings summarized below. These drawings and the associated description are provided to illustrate various embodiments, and not to limit the scope of the invention.

FIG. 1 illustrates an example external memory system for use with an electronic device that includes a device housing in accordance with certain embodiments described herein.

FIG. 2A illustrates an example of an external memory system having a memory device that is substantially enclosed by the package in accordance with certain embodiments described herein.

FIG. 2B illustrates an example of an external memory system having a memory device that is held between the package and the external surface of the housing in accordance with certain embodiments described herein.

FIGS. 3A-3C illustrate various examples of packages compatible with certain embodiments described herein.

FIG. 4 illustrates an example of one or more electrical conduits that may be used in accordance with certain embodiments described herein.

FIGS. 5A-5C illustrate various views of an example of a memory device having a flash memory that may be used in accordance with certain embodiments described herein.

FIG. 6 illustrates an example of a memory device having a rotating-storage drive memory in accordance with certain embodiments described herein.

FIG. 7 illustrates an example of an external coupler having a communication interface configured to be releasably operatively coupled to a memory device in accordance with certain embodiments described herein.

### DETAILED DESCRIPTION OF THE PREFERRED EMBODIMENT

Adding additional data storage capability to an electronic device can be achieved by adding memory externally to the device so as not to tamper with the functionality of the device (e.g., by opening the housing of the device). However, adding the capability of coupling to external memory may often be highly inconvenient because the external memory can have a significant impact on the profile of the electronic device. Advantageously, certain embodiments described herein include a low profile external system which provides the capability of using external memory with the electronic device.

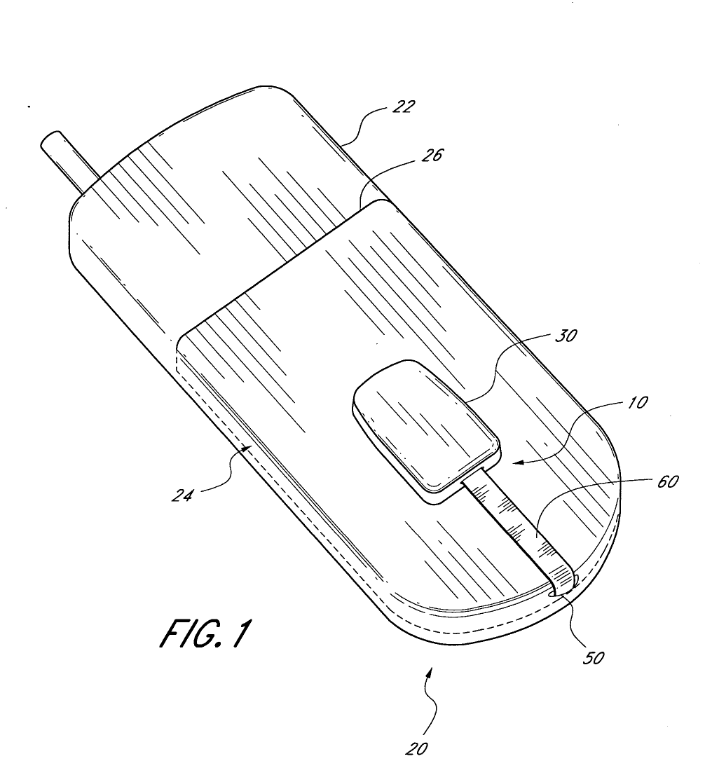

FIG. 1 illustrates an example external system 10 for use with an electronic device 20 that includes a device housing 22 and a dataport 50. The electronic device 20 is powered from within the housing 22. The system 10 comprises a memory device 30 held to the electronic device 20 in an external location relative to the electronic device 20. The memory device 30 is configured to provide the electronic device 20 with access to the memory device 30 as a source of memory external to the electronic device 20. The memory device 30 does not negatively impact handling of the electronic device 20 during use of the electronic device 20. The system 10 further comprises one or more electrical conduits 60 which are configured to electrically couple the memory device 30 to the dataport 50 so as to transmit signals between the memory device 30 and the dataport 50. The conduits 60 are configured to be affixed to the housing 22 of the electronic device 20 so as to closely follow a contour of the housing 22.

As schematically illustrated in FIG. 1, the electronic device 20 in certain embodiments comprises a cellular telephone having a memory expansion slot or dataport 50. The memory expansion dataport 50 can be accessible from a position external to the cellular telephone (see, e.g., FIG. 1), or can be accessible by opening a portion of the cellular telephone, such as the battery compartment (see, e.g., FIG. 4). Examples of cellular telephones compatible with embodiments described herein include, but are not limited to the Motorola ROKR, A780, A840, A1000, E398, E815, E1000, V635, V710, V850, V975, V980, V1000, Samsung D600 and Z500, and Kyocera KX5. In certain other embodiments, the electronic device 20 comprises other types of devices, including but not limited to portable media players such as music or video players (e.g., Apple iPod), digital cameras, personal digital assistants, and portable electronic mail devices (e.g., Blackberry, Palm Treo), as well as other devices having a memory card expansion dataport.

In certain embodiments, the electronic device 20 comprises a housing 22 which contains the various components of the electronic device 20 and which is configured to be held or handled by a user during operation of the electronic device 20. As schematically illustrated by FIG. 1, in certain embodiments, the electronic device 20 comprises a battery compartment 24 and the housing 22 comprises a battery compartment cover 26. The battery compartment 24 contains a battery (not shown) which provides power to the electronic device 20 such that the electronic device 20 is powered from within the housing 22. In certain embodiments, the battery and the battery compartment cover 26 are integral with one another and fit into the battery compartment 24.

In certain embodiments, the electronic device 20 further comprises a dataport 50 configured to transmit data (e.g., information data, music data, including ringtone data, and photographic and video data) between the electronic device 20 and an external device (e.g., an external storage device, a computer, other electronic devices such as a cellular telephone, music or video player, PDAs, and portable electronic mail devices). In certain embodiments, the dataport 50 comprises a plurality of pins (e.g., 8 pins), contacts, or optical ports configured to interface with a corresponding connector or plug of a cable comprising a plurality of conduits. Dataports 50 compatible with certain embodiments described herein have various architectures, including, but are not limited to, Secure Digital (SD), Mini-SD, Micro-SD (e.g., TransFlash or TFlash, available from SanDisk Corporation of Sunnyvale, California), MultiMediaCard (MMC), and Universal Serial Bus (USB).

In certain embodiments, the dataport 50 can be located inside the electronic device 20, e.g., within the housing 22 of the electronic device 20. In such embodiments, the conduits 60 transmitting signals between the memory device 30 and the dataport 50 may extend from outside the housing 22 of the electronic device 20 to inside the housing 22 of the electronic device 20 in order to access the dataport 50 of the electronic device 20. In certain other embodiments, the dataport 50 can be accessible from outside of the electronic device 20, e.g., from the external surface of the housing 22 of the electronic device 20. In those embodiments, the conduits 60 transmitting signals between the memory device 30 and the dataport 50 may remain outside the housing 22 of the electronic device 20.

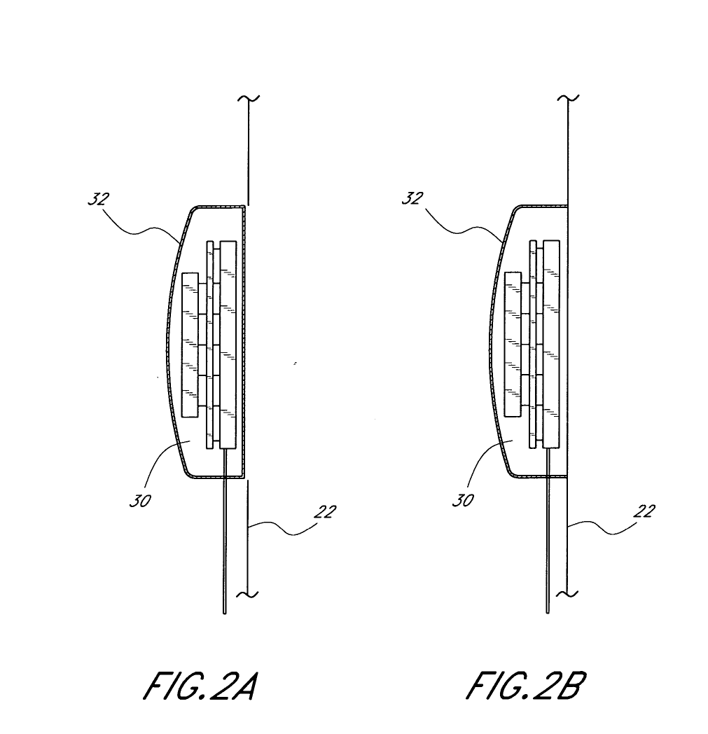

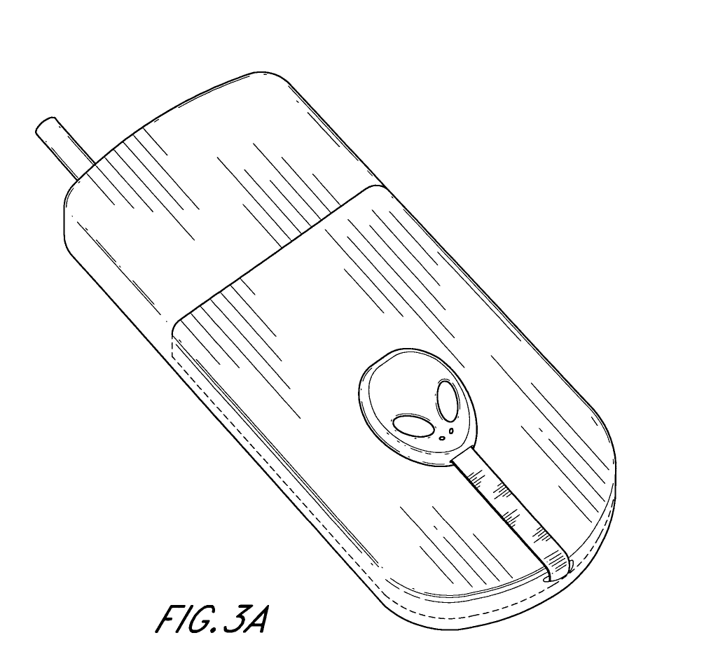

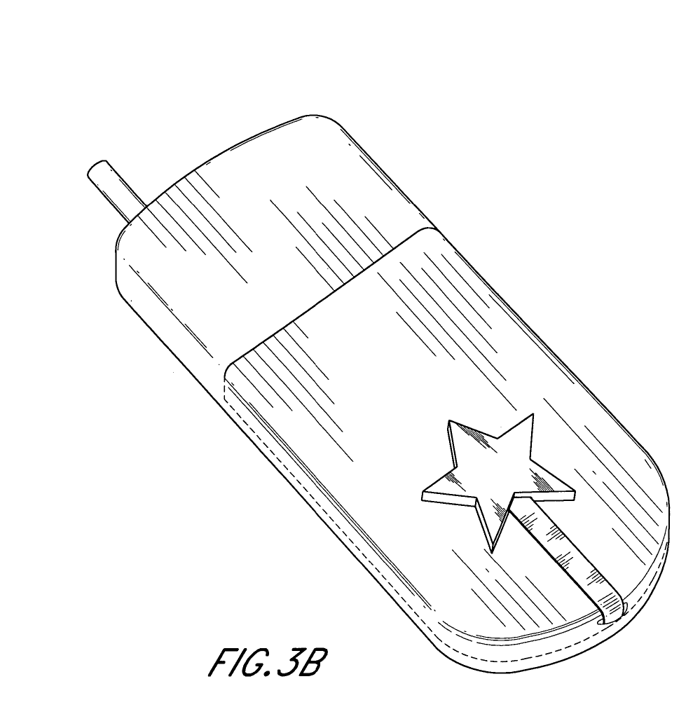

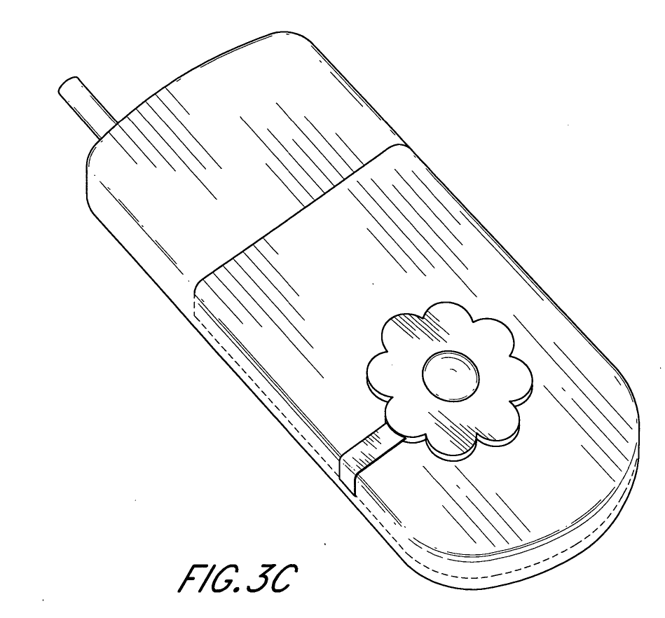

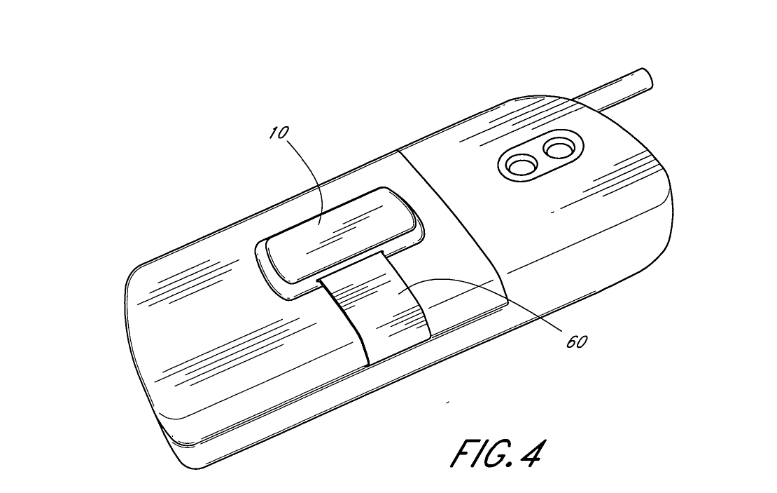

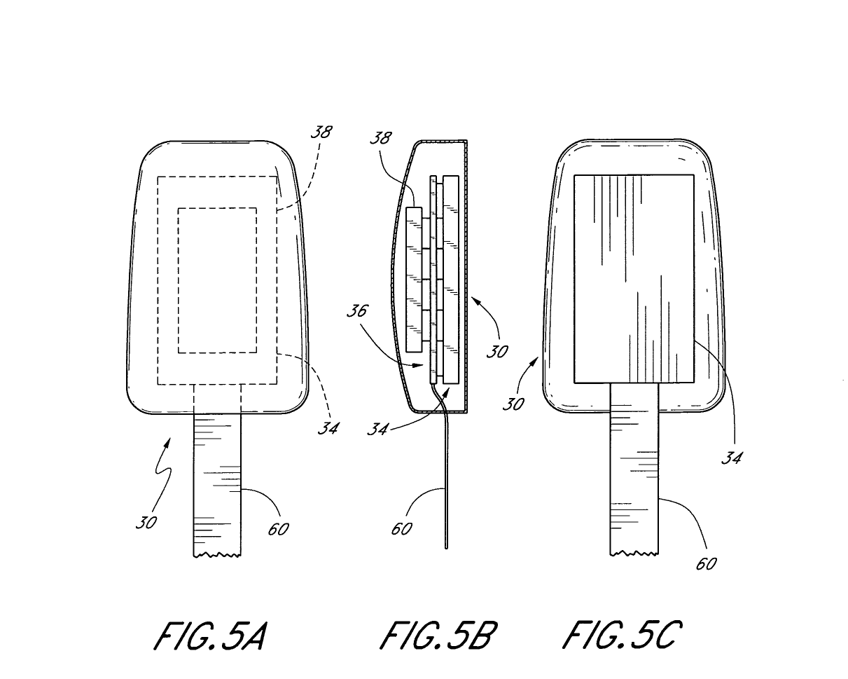

In certain embodiments, the memory device 30 comprises a package 32, a memory 34, a printed circuit board 36, and a memory controller 38, as schematically illustrated in FIGS. 2A and 2B. The package 32 may comprise a resilient material, such as rubber, plastic, or vinyl, and can be metal-plated in certain embodiments. The package 32 of certain embodiments serves as a support for the memory device 30. FIGS. 3A-3C illustrate various examples of packages 32 compatible with certain embodiments described herein. The package 32 may be substantially transparent or have a decorative appearance. The package 32 can have a wide variety of decorative appearances, including but not limited to, an alien head (FIG. 3A), a star (FIG. 3B), a plant (e.g., sunflower as shown in FIG. 3C), a fruit (e.g., lime), a company logo, and a cartoon (e.g., “Hello Kitty”).

In certain embodiments, the package 32 is visible during operation of the electronic device 20, thereby providing a way for the owner of the electronic device 20 to personalize the electronic device 20 by displaying a particular appearance to others. The package 32 of certain embodiments is configured to be affixed to an external surface of the housing 22. In certain embodiments, the package 32 adheres to the housing 22 with sufficient strength to remain affixed to the housing 22 during numerous cycles of use, handling, and storage of the electronic device 20. For example, the package 32 remains affixed to the housing 22 while being used by the user, while being carried in the user's pocket or handbag, and while being handled by the user.

In certain embodiments, the package 32 comprises an adhesive material which contacts the external surface of the housing 22 and the package 32 and which holds the package 32 onto the housing 22. In certain embodiments, the adhesive material comprises glue, epoxy, double-sided adhesive tape, or other material which adhere to both the package 32 and the housing. In certain embodiments in which the package 32 is removably and repeatably adhered to the housing 22 of the device 20, the adhesive is selected to be a non-permanent adhesive.

In certain embodiments, the package 32 is reversibly and repeatably adhered to the housing 22. In certain such embodiments, the package 32 can be easily removed, replaced, repositioned, or remounted on the same housing 22, on different portions of the housing 22, or on housings 22 of different electronic devices 20. In certain embodiments, other structures or configurations provide an adhesive force between the package 32 and the housing 22, including but not limited to, suction or air pressure forces (e.g., using suction cups), electrostatic or Van der Waals forces, magnetic forces (e.g., using magnets), and interlocking structures of the package 30 and the housing 22 (e.g., snap-on units).

In certain embodiments, the package 32 encloses the other components of the memory device 30, while in certain other embodiments the other components of the memory device 30 are held between the package 32 and the external surface of the housing 22. FIG. 2A illustrates an example of a memory device 30 in which the package 32 substantially encloses the memory 34, the printed circuit board 36, and the memory controller 38. As can be seen in FIG. 2A, only the package 32 contacts the external surface of the housing 22. The package 32 shown in FIG. 2A contacts the external surface of the housing 22 at least in a region between the memory device 30 and the external surface of the housing 22. In certain other embodiments, as shown in FIG. 2B, the package 32 does not completely enclose the other components of the memory device 30. In certain such embodiments, the memory 34, the printed circuit board 36, and the memory controller 38 of the memory device 30 may be held between the package 32 and the external surface of the housing 22. As illustrated in FIG. 2B, the package 32 contacts the external surface of the housing 22 in a region generally surrounding the other components of the memory device 30. In contrast to the embodiment shown in FIG. 2A, the other components of the memory device 30 illustrated in FIG. 2B can contact the external surface of the housing 22. Furthermore, as illustrated in both FIGS. 2A and 2B, the package 32 covers the other components of the memory device 30 on the side opposite to where the memory device 30 contacts the external surface of the housing 22. In certain embodiments, the other components of the memory device 30 are enclosed between the external surface of the housing 22 and the package 32. In certain other embodiments, the other components of the memory device 30 may not be fully enclosed between the external surface of the housing 22 and the package 32.

FIG. 4 illustrates an example of one or more conduits 60 in accordance with certain embodiments described herein. In certain embodiments, the conduits 60 are configured to electrically couple the memory device 30 to the dataport 50 of the electronic device 20. FIG. 4 illustrates an example in which the dataport 50 is accessible by opening the battery compartment of the electronic device 20 and running the conduits 60 from within the battery compartment to outside the battery compartment. In certain other embodiments, the dataport 50 is accessible by opening other portions of the electronic device 20.

In certain embodiments, the conduits 60 comprise a coupler configured to interface with the dataport 50. Examples of coupler architectures compatible with certain embodiments described herein include, but are not limited to, Secure Digital (SD), Mini-SD, Micro-SD (e.g., TransFlash or TFlash, available from SanDisk Corporation of Sunnyvale, California), MultiMedia Card (MMC), and Universal Serial Bus (USB). The conduits 60 are further configured to be affixed to the housing 22 of the electronic device 20 so as to closely follow a contour of the housing 22. The conduits 60 may be comprised of any number of materials, including but not limited to, copper and aluminum. The conduits 60 may be contained in any number of insulation materials, including but not limited to plastic, rubber, and polymer. In certain embodiments, the conduits 60 comprise a flexible printed-circuit-board. In certain embodiments, the electrical conduits 60 have a thickness of approximately 0.01 inches, while in certain other embodiments, the thickness of the electrical conduits 60 is less than approximately 1 millimeter, less than approximately 3 millimeters, or less than approximately 5 millimeters. Other thicknesses are also compatible with certain embodiments described herein. In certain embodiments, the conduits 60 comprise optical fibers which transmit optical signals between the memory device 30 and the dataport 50.

In certain embodiments, the conduits 60 adhere to the housing 22 with sufficient strength to remain affixed to the housing 22 during numerous cycles of use, handling, and storage of the electronic device 20. For example, the conduits 60 remain affixed to the housing 22 while being used by the user, while being carried in the user's pocket or handbag, and while being handled by the user. In certain embodiments, the conduits 60 comprise an adhesive material which contacts the external surface of the housing 22 and the conduits 60 so as to hold the conduits 60 onto the housing 22. In certain embodiments, the adhesive material comprises glue, epoxy, double-sided adhesive tape, or other material which adhere to both the conduits 60 and the housing 22. In certain embodiments in which the conduits 60 are removably and repeatably adhered to the housing 22 of the device 20, the adhesive is selected to be a non-permanent adhesive. In certain embodiments, the conduits 60 are reversibly and repeatably applied to the housing 22. In certain such embodiments, the conduits 60 can be easily removed, replaced, repositioned, or remounted on the same housing 22, on different portions of the housing 22, or on housings 22 of different electronic devices 20. In certain embodiments, other structures or configurations provide an adhesive force between the conduits 60 and the housing 22, including but not limited to, suction or air pressure forces (e.g., using suction cups), electrostatic or Van der Waals forces, magnetic forces (e.g., using magnets), and interlocking structures of the conduits 60 and the housing 22 (e.g., snap-on units). In some embodiments, the conduits 60 may be made retractable, using devices such as a spring and reel, in order to optimally expose as much of the conduits 60 as are necessary to form a connection between the memory device 30 and the dataport 50 of the electronic device 20.

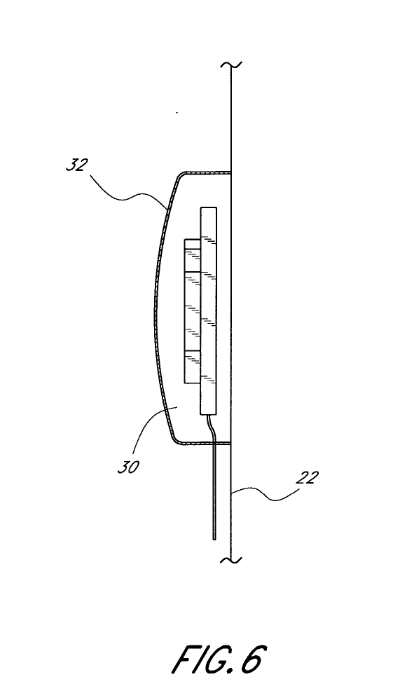

FIGS. 5A-5C illustrate various views of an example of a memory device 30 that may be used in accordance with certain embodiments described herein. The memory device 30 comprises a memory 34 comprising a flash memory integrated circuit, a printed circuit board 36 electrically coupled to the flash memory integrated circuit, and a memory controller 38 comprising a controller integrated circuit electrically coupled to the printed circuit board 36. In certain embodiments, the printed circuit board 36 and the conduits 60 are selected to provide desired electrical conductivity between the flash memory integrated circuit, the controller integrated circuit, and the dataport 50 of the electronic device 20. In certain embodiments, the memory device 30 is removably coupled to the conduits 60, while in other embodiments the memory device 30 and the conduits 60 are integral with one another. For example, in certain embodiments, the conduits 60 comprise a flexible printed-circuit-board (PCB) which is integral with the printed circuit board 36. In certain embodiments, the housing 32 of the memory device 30 has a length of approximately 0.8 inch, a width of approximately 0.52 inch, and a thickness of approximately 0.19 inch. Other dimensions are also compatible with certain embodiments described herein.

Examples of flash memory integrated circuits compatible with certain embodiments described herein include, but are not limited to, K9K1G08B0B 128 M×8-bit NAND flash memory integrated circuits available from Samsung Electronics Company, Limited of San Jose, California. Storage capacities of 1 GB, 2 GB, 4 GB, as well as other storage capacities, are compatible with certain embodiments described herein. Examples of controller integrated circuits compatible with embodiments described herein include, but are not limited to, PIC18FX flash microcontrollers available from Microchip Technology, Incorporated of Chandler, Arizona. Persons skilled in the art can select a flash memory integrated circuit and a controller integrated circuit compatible with certain embodiments described herein. The controller integrated circuit may be used for controlling data transmission to and from the flash memory integrated circuit 51. The flash memory integrated circuit may be used to provide additional data storage capacity for the electronic device 20.

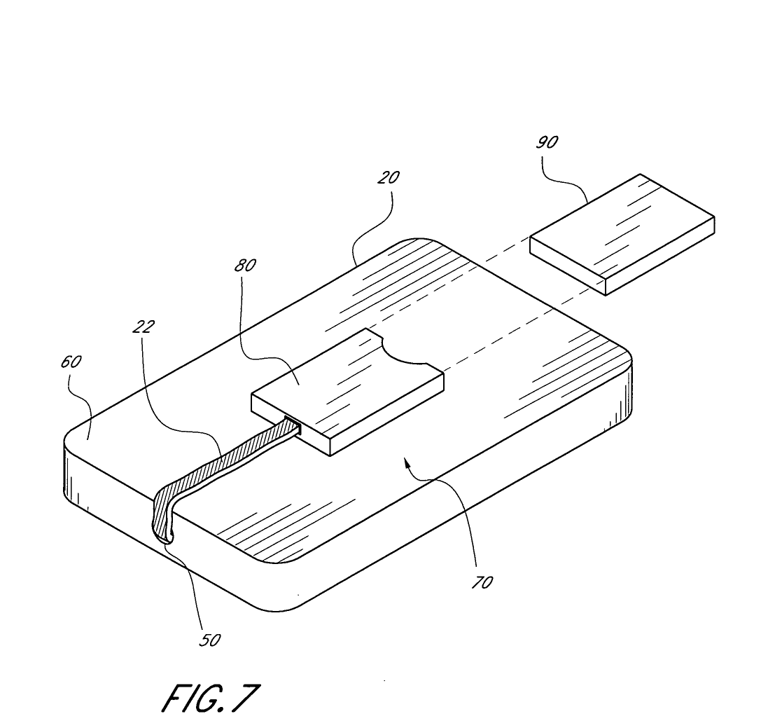

In certain embodiments, the memory device 30 comprises a hard disk drive (e.g., micro-drives) as schematically illustrated in FIG. 6. The memory device 30 comprises a memory 34 comprising a rotating-media drive, such as a hard disk drive or optical disk drive. The memory device 30 further comprises a drive connector 39 electrically coupled to the memory 34 and configured to be coupled to the electronic device 20 via the conduits 60. In certain embodiments, the drive connector 39 and the conduits 60 are selected to provide desired electrical conductivity between the rotating-media drive and the dataport 50 of the electronic device 20.

Examples of hard disk drives compatible with certain embodiments described herein include, but are not limited to, 4.8 GB or 2.2 GB “CF+Type II” one-inch hard disk drives such as the USQDP-2.2 QuikDisk 2.2 GB USB Pen Drive or the USMD-4GB Monstor Drive available from US Modular of Irvine, California. Storage capacities of 1 GB, 2 GB, 4 GB, as well as other storage capacities, are compatible with certain embodiments described herein. Persons skilled in the art can select a hard disk drive compatible with certain embodiments described herein.

As illustrated in FIG. 7, in certain embodiments, an external coupler 70 comprises a communication interface 80 held to the electronic device 20 in an external location relative to the electronic device 20. The communication interface 80 is configured to be operatively coupled to a source 90 of memory external to the device 20 (e.g., a memory device comprising a flash memory or a rotating-storage memory), thereby providing the electronic device 20 with access to the source 90 of memory external to the electronic device 20. Examples of architectures of the communication interface 80 compatible with certain embodiments described herein include, but are not limited to, Secure Digital (SD), Mini-SD, Micro-SD (e.g., TransFlash or TFlash, available from SanDisk Corporation of Sunnyvale, California), MultiMedia Card (MMC), and Universal Serial Bus (USB). The communication interface 80 does not negatively impact handling of the electronic device 20 during use of the electronic device 20. The coupler 70 further comprises one or more conduits 60 configured to electrically couple the communication interface 80 to the dataport 50 so as to transmit signals between the communication interface 80 and the dataport 50. The conduits 60 are configured to be affixed to the housing 22 of the electronic device 20 so as to closely follow a contour of the housing 22. In certain embodiments, the communication interface 80 is configured to be reversibly operatively coupled to the source 90 of memory external to the device 20, while in certain other embodiments, the communication interface 80 is integral with the source of memory.

The external system 10 of certain embodiments is advantageously low-profile so as to not negatively impact handling of the electronic device 20 during its use. For example, the external system 10 remains affixed to the housing 22 while being used by the user, while being carried in the user's pocket or handbag, and while being handled by the user. The low profile of the system 10 allows for the combination of the system 10 and the electronic device 20 to be easily handled when an individual is using the electronic device 20. The low profile of the external system 10 also allows for the combination of the system 10 and the electronic device 20 to be easily stored, docked, or otherwise used with accessories designed for the electronic device 20 without the system 10.

It will be appreciated by those skilled in the art that the above-described straightforwardly adapted or extended in various ways. While the foregoing description makes reference to particular embodiments, the scope of the invention is defined aims that follow and the elements recited therein.

What is claimed is:

1. An external flash memory system for use with a cellular telephone that includes an 8-pin dataport and a telephone housing, the cellular telephone powered from within the telephone housing, the external flash memory system comprising:
a resilient support configured to have a decorative appearance, the support further configured to be affixed to an external surface of the telephone housing by an adhesive, and wherein the support does not negatively impact handling of the telephone during use of the telephone;
a low-profile flash memory device supported by the support, the flash memory device comprising:
a flash memory integrated circuit;
a printed circuit board electrically coupled to the flash memory integrated circuit; and
a controller integrated circuit electrically coupled to the printed circuit board for controlling data transmission to and from the flash memory integrated circuit; and
a plurality of electrical conduits configured to electrically couple the flash memory device to the 8-pin dataport of the cellular telephone, the conduits configured to be affixed to the telephone housing so as to closely follow a contour of the housing.

2. An external system for use with an electronic device, the device having a device housing and a dataport, the device powered from within the housing, the external system comprising:
an apparatus held to the electronic device in an external location relative to the electronic device, the apparatus configured to provide the electronic device with access to a source of memory external to the device, wherein the apparatus does not negatively impact handling of the electronic device during use of the electronic device; and
one or more conduits which are configured to transmit signals between the apparatus and the dataport, the conduits configured to be affixed to the housing so as to closely follow a contour of the housing.

3. The external system of claim 2, wherein the apparatus comprises the source of memory external to the electronic device.

4. The external system of claim 3, wherein the source of memory is a flash memory device.

5. The external system of claim 3, wherein the source of memory is a rotating-storage drive.

6. The external system of claim 2, wherein the apparatus comprises a communication interface configured to be removably operatively coupled to the source of memory.

7. An external memory system for use with an electronic device that includes a device housing, the device powered from within the housing, the external memory system comprising:
a memory device held to the electronic device in an external location relative to the electronic device, wherein the memory device does not negatively impact handling of the electronic device during use of the electronic device; and
one or more electrical conduits which are configured to electrically couple the memory device to a dataport of the electronic device, the conduits configured to be affixed to the housing so as to closely follow a contour of the housing.

8. The external memory system of claim 7, wherein the electronic device comprises a cellular telephone.

9. The external memory system of claim 7, wherein the memory device comprises a package mountable on an external surface of the electronic device.

10. The external memory system of claim 9, wherein the electronic device comprises a battery module, the package mountable on an external surface of the battery module.

11. The external memory system of claim 9, wherein the package is viewable during operation of the electronic device.

12. The external memory system of claim 9, wherein the package comprises a resilient material.

13. The external memory system of claim 12, wherein the resilient material comprises rubber, plastic, or vinyl.

14. The external memory system of claim 9, wherein the package is substantially transparent.

15. The external memory system of claim 9, wherein the package has a decorative appearance.

16. The external memory system of claim 9, wherein the package is affixed to the external surface of the electronic device by adhesive.

17. The external memory system of claim 9, wherein the package encloses the memory device.

18. The external memory system of claim 9, wherein the external location is between the package and the external surface of the electronic device.

19. The external memory system of claim 7, wherein the memory device comprises a hard disk drive.

20. The external memory system of claim 7, wherein the memory device comprises a flash memory device.

21. The external memory system of claim 20, wherein the flash memory device comprises:
a flash memory integrated circuit;
a printed circuit board electrically coupled to the memory integrated circuit; and
a controller integrated circuit electrically coupled to the printed circuit board.

22. The external memory system of claim 7, wherein the external memory system provides additional data storage capacity for the electronic device.

23. An electronic apparatus comprising:
a cellular telephone that includes a telephone housing and a dataport, the cellular telephone powered from within the telephone housing; and
a memory system comprising:
a package mountable on an external surface of the cellular telephone; and
a memory device held by the package in an external location relative to the cellular telephone; and
one or more electrical conduits which are configured to electrically couple the memory device to the dataport, the conduits configured to be affixed to the housing so as to closely follow a contour of the housing.

24. An external system for use with an electronic device, the device having a device housing and a dataport, the device powered from within the housing, the external system comprising:
access means for providing access to a source of memory external to the device, the access means held to the electronic device in an external location relative to the electronic device, wherein the access means does not negatively impact handling of the electronic device during use of the electronic device;
packaging means for coupling the access means to an external surface of the housing; and
transmitting means for transmitting signals between the access means and the dataport, the transmitting means configured to be affixed to the housing so as to closely follow a contour of the housing.

25. An external coupler for use with an electronic device that includes a device housing and a dataport, the device powered from within the housing, the external coupler comprising:
a communication interface held to the electronic device in an external location relative to the electronic device, the communication interface configured to be operatively coupled to a source of memory external to the electronic device, wherein the communication interface does not negatively impact handling of the electronic device during use of the electronic device; and
one or more conduits configured to transmit signals between the communication interface and the dataport, the conduits configured to be affixed to the housing so as to closely follow a contour of the housing.

26. The external coupler of claim 25, wherein the communication interface is configured to be reversibly operatively coupled to the source of memory external to the electronic device.

27. The external coupler of claim 25, wherein the electronic device comprises a cellular telephone.

28. The external coupler of claim 25, wherein the communication interface comprises a package mountable on an external surface of the electronic device.

29. The external coupler of claim 28, wherein the electronic device comprises a battery module, the package mountable on an external surface of the battery module.

30. The external coupler of claim 28, wherein the package comprises a resilient material.

31. The external coupler of claim 30, wherein the resilient material comprises rubber, plastic, or vinyl.
